(19) United States
(12) Patent Application Publication
(10) Pub. No.: US 2017/0334253 A1
(43) Pub. Date: Nov. 23, 2017

(54) Wireless Tire Pressure Monitoring System and Operating Method Thereof

(71) Applicant: Gofull Technology Co., Ltd., Hsinchu City (TW)

(72) Inventor: Hsiu-Ping Chuang, Hsinchu City (TW)

(21) Appl. No.: 15/274,959

(22) Filed: Sep. 23, 2016

(30) Foreign Application Priority Data
May 23, 2016 (TW) 105115901

(51) Int. Cl. B60C 23/04; G01L 19/00

(52) U.S. Cl. CPC B60C 23/0486; G01L 19/0092; B60C 23/041; B60C 23/0433; B60C 23/0481

(57) ABSTRACT

The invention relates to a wireless tire pressure monitoring system provided on a tire or a rim of a vehicle. The system includes: a magnetometer for measuring a magnetic flux value; a pressure sensor for measuring a pressure value within the tire; a controller for receiving the magnetic flux value measured by the magnetometer and the pressure value measured by the pressure sensor, and determining whether the magnetic flux value fluctuates; and a wireless signal transmitter in signal communication with the controller, and controlled by the controller, wherein when the controller determines that the magnetic flux value fluctuates, the controller activates the wireless signal transmitter or raises the transmitting times per minute of the wireless signal transmitter and the wireless signal transmitter transmits a signal which represents the pressure value. The invention also relates to a method for operating a wireless tire pressure monitoring system.

### CLAIM OF PRIORITY

This application claims the priority benefit of Taiwan Application Serial No. TW105115901, filed on May 23, 2016. All disclosure thereof is incorporated herein by reference.

### BACKGROUND OF THE INVENTION

### A. Field of the Invention

This invention relates to a wireless tire pressure monitoring system and an operating method of the wireless tire pressure monitoring system.

### B. Description of the Prior Art

In a conventional wireless tire pressure monitoring system, in order to reduce its battery consumption, a gravitational acceleration sensor (G-sensor) is used as a switch for a wireless signal transmitter. Specifically, when the vehicle is stationary, the gravitational acceleration sensor would not sense any change in the gravitational acceleration, and in this case the wireless signal transmitter is not activated and remains in a sleep state so as to reduce battery consumption. On the contrary, while the vehicle is moving, the gravitational acceleration sensor would sense changes in the gravitational acceleration, and in this case a controller of the wireless tire pressure monitoring system can activate the wireless signal transmitter according to the measurement of the gravitational acceleration sensor and put the wireless signal transmitter into an operating state.

The sensing device in the gravitational acceleration sensor typically has a spring-like structure. Such a structure is susceptible to damage caused by rough road conditions, which would result in malfunction of the gravitational acceleration sensor and then shorten the lifetime of the wireless tire pressure monitoring system.

### SUMMARY OF THE INVENTION

In view of the above problem, a wireless tire pressure monitoring system is provided according to an embodiment of the present invention, wherein the wireless tire pressure monitoring system is provided on a tire or a rim of a vehicle. The wireless tire pressure monitoring system comprises: a magnetometer for measuring a magnetic flux value; a pressure sensor for measuring a pressure value within the tire; a controller, receiving the magnetic flux value measured by the magnetometer and the pressure value measured by the pressure sensor, and determining whether the magnetic flux value fluctuates; and a wireless signal transmitter in signal communication with the controller and controlled by the controller, wherein when the controller determines that the magnetic flux value fluctuates, the controller activates the wireless signal transmitter or raises the transmitting times per minute of the wireless signal transmitter, and the wireless signal transmitter transmits a signal representing the pressure value.

According to an embodiment of the present invention, a wireless tire pressure monitoring system is provided, wherein the wireless tire pressure monitoring system is provided on a tire or a rim of a vehicle. The wireless tire pressure monitoring system comprises: a magnetometer for measuring a magnetic flux value; a pressure sensor for measuring a pressure value within the tire; a controller, receiving the magnetic flux value measured by the magnetometer and the pressure value measured by the pressure sensor, and determining whether the magnetic flux value reaches a predetermined threshold; and a wireless signal transmitter in signal communication with the controller and controlled by the controller, wherein when the controller determines that the magnetic flux value reaches the predetermined threshold, the controller activates the wireless signal transmitter or raises the transmitting times per minute of the wireless signal transmitter, and the wireless signal transmitter transmits a signal representing the pressure value.

According to an embodiment of the present invention, a method of operating a wireless tire pressure monitoring system is provided, the wireless tire pressure monitoring system provided on a tire or a rim of a vehicle and comprising: a magnetometer, a pressure sensor, a controller in signal communication with the magnetometer and the pressure sensor, and a wireless signal transmitter in signal communication with the controller and controlled by the controller. The method comprises: measuring a magnetic flux value by the magnetometer; measuring a pressure value within the tire by the pressure sensor; receiving, by the controller, the magnetic flux value measured by the magnetometer and the pressure value measured by the pressure sensor, determining, by the controller, whether the magnetic flux value fluctuates; and activating the wireless signal transmitter or raising the transmitting times per minute of the wireless signal transmitter by the controller when the controller determines that the magnetic flux value fluctuates, and transmitting a signal representing the pressure value by the wireless signal transmitter.

According to another embodiment of the present invention, a method of operating a wireless tire pressure monitoring system is provided, the wireless tire pressure monitoring system provided on a tire or a rim of a vehicle and comprising: a magnetometer, a pressure sensor, a controller in signal communication with the magnetometer and the pressure sensor, and a wireless signal transmitter in signal communication with the controller and controlled by the controller. The method comprises: measuring a magnetic flux value by the magnetometer; measuring a pressure value within the tire by the pressure sensor; receiving, by the controller, the magnetic flux value measured by the magnetometer and the pressure value measured by the pressure sensor, determining, by the controller, whether the magnetic flux value reaches a predetermined threshold; and activating the wireless signal transmitter or raising the transmitting times per minute of the wireless signal transmitter by the controller when the controller determines that the magnetic flux value reaches the predetermined threshold, and transmitting a signal representing the pressure value by the wireless signal transmitter.

Compared to a conventional wireless tire pressure monitoring system which uses a gravitational acceleration sensor with a spring structure, the magnetometer employed by the wireless tire pressure monitoring system of the invention does not have such a spring structure, and thus is not susceptible to damage caused by rough road conditions, thereby extending lifetime of the wireless tire pressure monitoring system and reducing battery consumption.

Other aspects and advantages of the invention will become apparent by reference to the following detailed description combined with the appended drawings for illustrating the principle examples of the invention. In addition, well-known devices and principles are not further described in the specification so as not to unnecessarily obscure the invention.

### BRIEF DESCRIPTION OF THE DRAWINGS

FIG. 1 is a structural schematic diagram schematically showing a wireless tire pressure monitoring system 1 according to an embodiment of the present invention;

FIG. 2 is a cross-sectional schematic diagram showing a tire provided with the wireless tire pressure monitoring system of the present invention and illustrates the relation between the location of the magnetometer of the wireless tire pressure monitoring system and the measured value thereof while the vehicle is moving according to an embodiment of the invention;

FIG. 3 is a cross-sectional schematic diagram showing a tire provided with the wireless tire pressure monitoring system of the present invention, and illustrates the relation between the location of the magnetometer of the wireless tire pressure monitoring system and the measured value thereof while the vehicle is moving according to an embodiment of the invention;

FIGS. 4A and 4B illustrate the operating principle of the wireless tire pressure monitoring system showed in FIGS. 2 and 3; and

FIG. 5 is a schematic diagram of a vehicle, wherein the front wheel and the rear wheel of the vehicle are provided with the wireless tire pressure monitoring systems of the invention according to an embodiment of the invention.

### DETAILED DESCRIPTION OF THE PREFERRED EMBODIMENTS

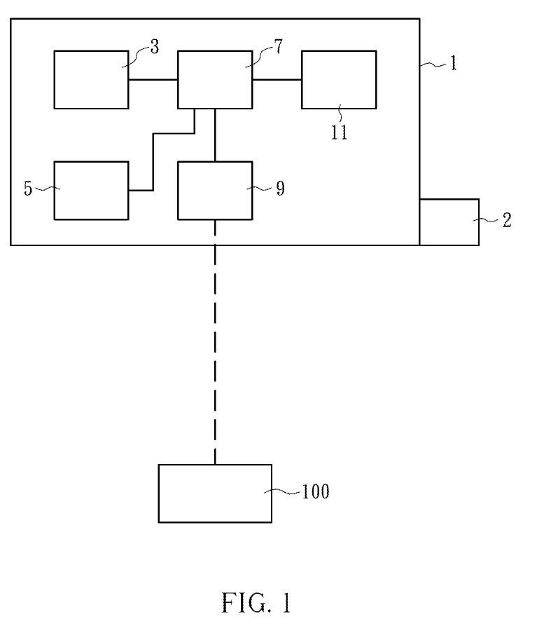

FIG. 1 is a structural schematic diagram schematically showing a wireless tire pressure monitoring system 1 according to an embodiment of the present invention. The wireless tire pressure monitoring system 1 can be provided on a rim of a vehicle, or on a tire of the vehicle (for example, embedded into an inner side of the tire which does not contact the road surface, or fixed to a surface of the inner side of the tire). As depicted in FIG. 1, the wireless tire pressure monitoring system 1 can comprise: a magnetometer 3 for measuring a magnetic flux value; a pressure sensor 5 for measuring a pressure value within the tire; a controller 7 in signal communication with the magnetometer 3 and the pressure sensor 5; and a wireless signal transmitter 9 in signal communication with the controller 7 and controlled by the controller 7. In an embodiment, the controller 7 can be configured to receive the magnetic flux value measured by the magnetometer 3 and the pressure value measured by the pressure sensor 5, and determine whether the magnetic flux value fluctuates. In another embodiment, the controller 7 can be configured to receive the magnetic flux value measured by the magnetometer 3 and the pressure value measured by the pressure sensor 5, and determine whether the magnetic flux value reaches a predetermined threshold.

For example, in an embodiment of the present invention, the wireless tire pressure monitoring system 1 can be electrically connected to a battery 2, and the battery 2 can be used for supplying power to the wireless tire pressure monitoring system 1. The controller 7 can be, for instance, a microcontroller having an analog/digital conversion function, but is not limited thereto.

Furthermore, in an embodiment, the wireless tire pressure monitoring system 1 can further comprise a temperature sensor 11 in signal communication with the controller 7. The temperature sensor 11 can be configured to measure a temperature value within the tire, and the controller 7 can receive the temperature value measured by the temperature sensor 11.

In an embodiment of the present invention, the wireless signal transmitter 9 can be, for instance, a wireless radio frequency (RF) signal transmitter, but is not limited thereto.

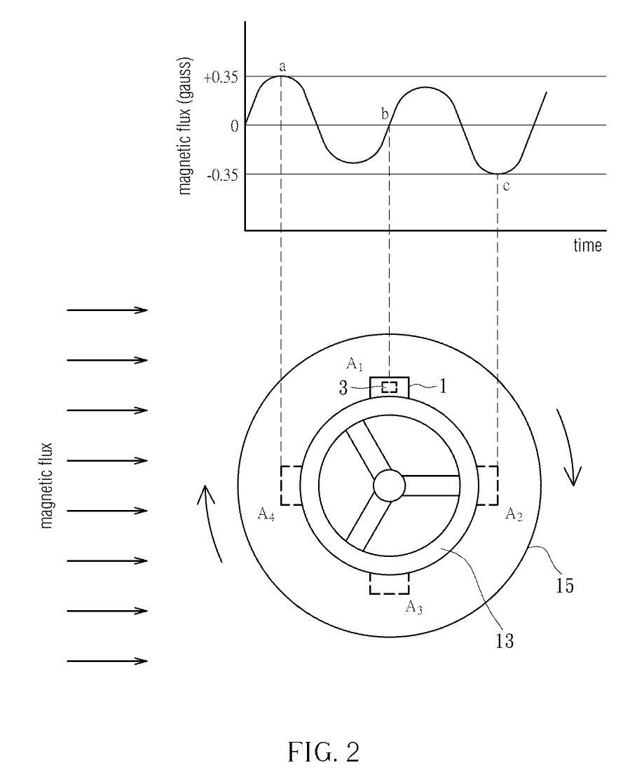

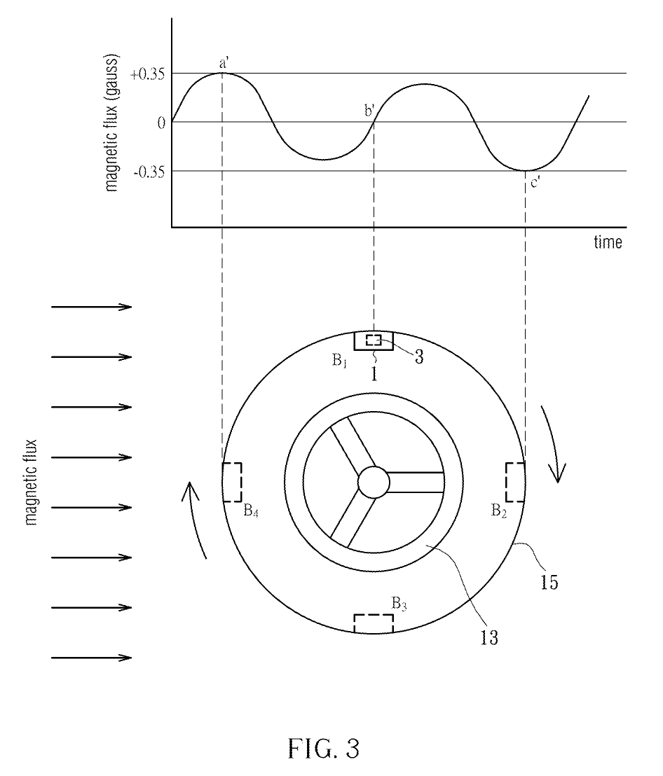

FIG. 2 is a cross-sectional schematic diagram, showing a tire provided with the wireless tire pressure monitoring system 1 of the present invention according to an embodiment of the invention. FIG. 2 illustrates the relation between the location of the magnetometer 3 of the wireless tire pressure monitoring system 1 and the measured value thereof while the vehicle is moving, wherein the wireless tire pressure monitoring system 1 is provided on a rim 13. According to another embodiment of the invention, FIG. 3 shows a cross-sectional schematic diagram of a tire provided with the wireless tire pressure monitoring system 1 of the invention. FIG. 3 illustrates the relation between the location of the magnetometer 3 of the wireless tire pressure monitoring system 1 and the measured value thereof while the vehicle is moving, wherein the wireless tire pressure monitoring system 1 is provided on a tire 15 of the vehicle, for example, embedded into a tire inner side which does not contact the road surface, or fixed to a surface of the inner side of the tire.

As depicted in FIG. 2, in the case where the wireless tire pressure monitoring system 1 is provided on the rim 13, the wireless tire pressure monitoring system 1 rotates along with the rim 13 (as indicated by the arrows) while the vehicle is moving. In this situation, because the location of the wireless tire pressure monitoring system 1 changes sequentially through A₁, A₂, A₃, and A₄, the magnetic flux (ambient magnetic flux) (unit: gauss) passing through the magnetometer 3 of the wireless tire pressure monitoring system 1 would change correspondingly. For example, at locations A₂ and A₄ the magnetic flux passing through the magnetometer 3 of the wireless tire pressure monitoring system 1 reaches its maximum, as depicted at points a and c on the curve of FIG. 2; at locations A₁ and A₃ the magnetic flux passing through the magnetometer 3 of the wireless tire pressure monitoring system 1 reaches its minimum, as depicted at the point b on the curve of FIG. 2.

Furthermore, as depicted in FIG. 3, in the case where the wireless tire pressure monitoring system 1 is provided on the tire 15 of the vehicle, the wireless tire pressure monitoring system 1 rotates along with the tire 15 (as indicated by the arrows) while the vehicle is moving. In this situation, because the location of the wireless tire pressure monitoring system 1 changes sequentially through B₁, B₂, B₃, and B₄, the magnetic flux (ambient magnetic flux) passing through the magnetometer 3 of the wireless tire pressure monitoring system 1 would change correspondingly. For example, at locations B₂ and B₄ the magnetic flux passing through the magnetometer 3 of the wireless tire pressure monitoring system 1 reaches its maximum, as depicted at points a′ and c′ on the curve of FIG. 3; at locations B₁ and B₃ the magnetic flux passing through the magnetometer 3 of the wireless tire pressure monitoring system 1 reaches its minimum, as depicted at the point b′ on the curve of FIG. 3. It can be appreciated that the magnetic flux (ambient magnetic flux) would vary due to difference in geographic location, and thus the magnetic flux values marked on the vertical axes in FIGS. 2 and 3 are exemplary but not limited thereto.

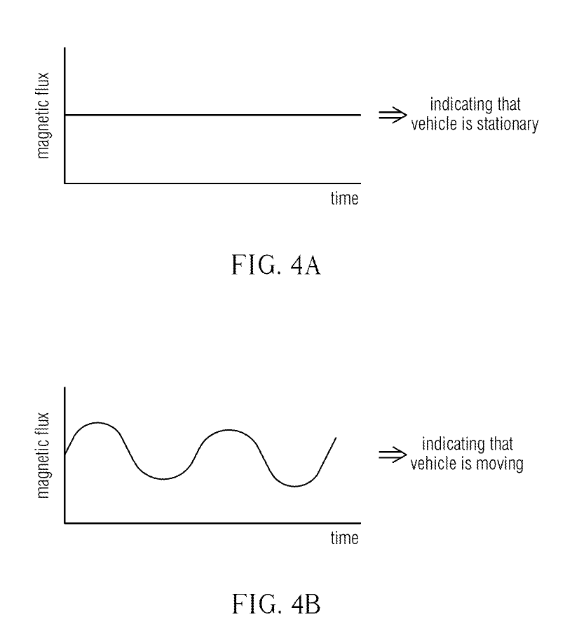

FIGS. 4A and 4B illustrate the operating principle of the wireless tire pressure monitoring system showed in FIGS. 2 and 3. As depicted in FIG. 4A, the measured magnetic flux value does not fluctuate; the reason is that the location of the wireless tire pressure monitoring system 1 does not change and thus the magnetic flux passing through the magnetometer 3 of the wireless tire pressure monitoring system does not change either, that is, implying that the vehicle is stationary. On the contrary, as depicted in FIG. 4B, the measured magnetic flux value fluctuates; the reason is that the location of the wireless tire pressure monitoring system 1 changes along with the rotation of the rim 13 or tire 15, and thus the magnetic flux passing through the magnetometer 3 of the wireless tire pressure monitoring system also changes, that is, implying that the vehicle is moving. Accordingly, the controller 7 can determine whether the measured magnetic flux value fluctuates or can determine whether the measured magnetic flux value reaches a predetermined threshold. According to the determination, the controller can further activate the wireless signal transmitter 9 or change the frequency of times the wireless signal transmitter 9 transmits signals.

According to an embodiment of the invention, the operating method of the wireless tire pressure monitoring system 1 can comprise: measuring a magnetic flux value by the magnetometer 3; measuring a pressure value within the tire 15 by the pressure sensor 5; receiving, by the controller 7, the magnetic flux value measured by the magnetometer 3 and the pressure value measured by the pressure sensor 5, and determining, by the controller 7, whether the magnetic flux value fluctuates; and activating the wireless signal transmitter 9 or raising the transmitting times per minute of the wireless signal transmitter 9 by the controller 7 when the controller 7 determines that the magnetic flux value fluctuates, and transmitting, by the wireless signal transmitter 9, a signal representing the pressure value.

Furthermore, in an embodiment, a temperature sensor 11 can be configured to measure a temperature value within the tire 15, and the controller 7 can receive the temperature value measured by the temperature sensor 11. When the controller 7 determines that the magnetic flux value fluctuates, the controller 7 can activate the wireless signal transmitter 9 or increase the transmitting times per minute of the wireless signal transmitter 9, and the wireless signal transmitter 9 can transmit a signal representing the temperature value.

In another embodiment, the battery level of the battery 2 can be detected through the controller 7. When the controller 7 determines that the magnetic flux value fluctuates, the controller 7 can activate the wireless signal transmitter 9 or increase the transmitting times per minute of the wireless signal transmitter 9, and the wireless signal transmitter 9 can transmit a signal representing the battery level.

According to another embodiment of the invention, the operating method of the wireless tire pressure monitoring system 1 can comprise: measuring a magnetic flux value by the magnetometer 3; measuring a pressure value within the tire 15 by the pressure sensor 5; receiving, by the controller 7, the magnetic flux value measured by the magnetometer 3 and the pressure value measured by the pressure sensor 5, and determining, by the controller 7, whether the magnetic flux value reaches a predetermined threshold; and activating the wireless signal transmitter 9 or raising the transmitting times per minute of the wireless signal transmitter 9 by the controller 7 when the controller 7 determines that the magnetic flux value reaches the predetermined threshold, and transmitting a signal representing the pressure value by the wireless signal transmitter 9. The predetermined threshold can be, for instance, any point on the curves showed in FIG. 2 or FIG. 3, such as points a, b, or c in FIG. 2, or points a′, b′, or c′ in FIG. 3, but is not limited thereto.

In addition, in an embodiment, the controller 7 receives the temperature value measured by the temperature sensor 11. When the controller 7 determines that the magnetic flux value reaches the predetermined threshold, the controller 7 can activate the wireless signal transmitter 9 or increase the transmitting times per minute of the wireless signal transmitter 9, and the wireless signal transmitter 9 transmits a signal representing the temperature value.

In another embodiment, the battery level of the battery 2 can be detected through the controller 7. When the controller 7 determines that the magnetic flux value reaches the predetermined threshold, the controller 7 can activate the wireless signal transmitter 9 or increase the transmitting times per minute of the wireless signal transmitter 9, and the wireless signal transmitter 9 transmits a signal representing the battery level value.

As depicted in FIG. 1, a signal transmitted by the wireless signal transmitter 9 can be received by a signal receiver 100. The signal receiver 100 is typically installed on or near the dashboard of the vehicle, so that at any time the driver can read the signals transmitted by the wireless signal transmitter 9, the signals representing the pressure or temperature within a tire or representing the battery level.

Iron wires inside a tire, the rim, and metal structure (for example, the bodyshell or chassis) of the vehicle itself may have a shielding effect on wireless signal transmission. Moreover, the relative location between the signal receiver 100 installed inside the vehicle and the tire may vary. Therefore, it is possible that signal transmission efficiency of the wireless tire pressure monitoring system is inconsistent at various locations of the tire. When the wireless signal transmitter of the wireless tire pressure monitoring system transmits signals at a location with poorer transmission efficiency, the signal receiver 100 may not receive the signals. In this situation, in order to ensure that the signal receiver 100 can receive signals, the wireless signal transmitter may need to continuously transmit signals for a long time, which may increase battery consumption.

As described above, while the vehicle is moving, the wireless tire pressure monitoring system rotates along with the tire or the rim, and thus the location of the wireless tire pressure monitoring system can be determined by the measured magnetic flux. If the controller of the wireless tire pressure monitoring system activates the wireless signal transmitter or increases transmitting times of the wireless signal transmitter only when the wireless tire pressure monitoring system rotates along with the tire or the rim to a location with the best signal transmission efficiency, the battery consumption can be reduced.

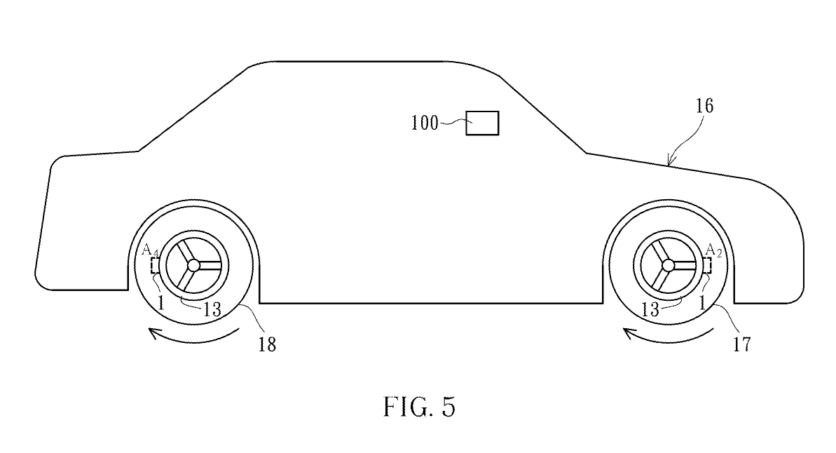

According to an embodiment of the invention, FIG. 5 is a schematic diagram of a vehicle 16, wherein the front wheel 17 and the rear wheel 18 of the vehicle 16 are provided with the wireless tire pressure monitoring systems 1 of the invention. For example, it is assumed that the wireless tire pressure monitoring system 1 of the front wheel 17 can have the best signal transmission efficiency at a location A₂ (corresponding to the location A₂ in FIG. 2) and the wireless tire pressure monitoring system 1 of the rear wheel 18 can have the best signal transmission efficiency at a location A₄ (corresponding to the location A₄ in FIG. 2), When the wireless tire pressure monitoring system 1 of the front wheel 17 detects a magnetic flux value corresponding to the point c in FIG. 2 (i.e. indicating that the wireless tire pressure monitoring system 1 of the front wheel 17 is at the location A₂), the wireless signal transmitter thereof can be activated or the transmitting times per minute of the wireless signal transmitter can be increased. Similarly, when the wireless tire pressure monitoring system 1 of the rear wheel 18 detects a magnetic flux value corresponding to the point a in FIG. 2 (i.e. indicating that the wireless tire pressure monitoring system 1 of the back wheel 18 is at the location A₄), the wireless signal transmitter thereof can be activated or the transmitting times per minute of the wireless signal transmitter can be increased.

While the present invention has been shown and described by reference to preferred embodiments thereof, and in terms of the illustrative drawings, various possible modifications, alterations, and equivalent substitution could be conceived of by one skilled in the art without departing from the sprit and the scope of the present invention. However, such modifications, alterations, and substitutions still fall within the scope of the claims of the present invention.

What is claimed is:

1. A method of operating a wireless tire pressure monitoring system, the wireless tire pressure monitoring system being provided on a tire or a rim of a vehicle and comprising:
a magnetometer,
a pressure sensor,
a controller in signal communication with the magnetometer and the pressure sensor, and
a wireless signal transmitter in signal communication with the controller and controlled by the controller,
said method comprising:
measuring a magnetic flux value by the magnetometer;
measuring a pressure value within the tire by the pressure sensor;
receiving, by the controller, the magnetic flux value measured by the magnetometer and the pressure value measured by the pressure sensor, and determining, by the controller, whether the magnetic flux value fluctuates; and
activating the wireless signal transmitter or raising the transmitting times per minute of the wireless signal transmitter by the controller when the controller determines that the magnetic flux value fluctuates, and transmitting a signal representing the pressure value by the wireless signal transmitter.

2. The method of claim 1, wherein the wireless tire pressure monitoring system further comprises a temperature sensor in signal communication with the controller, and said method further comprises:
measuring a temperature value within the tire by the temperature sensor; and
receiving, by the controller, the temperature value measured by the temperature sensor; and when the controller determines that the magnetic flux value fluctuates, activating the wireless signal transmitter or raising the transmitting times per minute of the wireless signal transmitter by the controller, and transmitting a signal representing the temperature value by the wireless signal transmitter.

3. The method of claim 1, wherein the wireless tire pressure monitoring system is electrically connected to a battery, and the battery is used for supplying power to the wireless tire pressure monitoring system,
said method further comprises:
detecting battery level of the battery through the controller; and when the controller determines that the magnetic flux value fluctuates, activating the wireless signal transmitter or raising the transmitting times per minute of the wireless signal transmitter by the controller, and transmitting a signal representing the battery level by the wireless signal transmitter.

4. The method of claim 1, wherein the wireless signal transmitter is a wireless radio frequency signal transmitter.

5. A method of operating a wireless tire pressure monitoring system, the wireless tire pressure monitoring system provided on a tire or a rim of a vehicle and comprising:
a magnetometer,
a pressure sensor,
a controller in signal communication with the magnetometer and the pressure sensor, and
a wireless signal transmitter in signal communication with the controller and controlled by the controller,
said method comprising:
measuring a magnetic flux value by the magnetometer;
measuring a pressure value within the tire by the pressure sensor;
receiving, by the controller, the magnetic flux value measured by the magnetometer and the pressure value measured by the pressure sensor, and determining, by the controller, whether the magnetic flux value reaches a predetermined threshold; and
activating the wireless signal transmitter or raising the transmitting times per minute of the wireless signal transmitter by the controller when the controller determines that the magnetic flux value reaches the predetermined threshold, and transmitting a signal representing the pressure value by the wireless signal transmitter.

6. The method of claim 5, wherein the wireless tire pressure monitoring system further comprises a temperature sensor in signal communication with the controller, and said method further comprises:
measuring a temperature value within the tire by the temperature sensor; and
receiving, by the controller, the temperature value measured by the temperature sensor; and when the controller determines that the magnetic flux value reaches the predetermined threshold, activating the wireless signal transmitter or raising the transmitting times per minute of the wireless signal transmitter by the controller, and transmitting a signal representing the temperature value by the wireless signal transmitter.

7. The method of claim 5, wherein the wireless tire pressure monitoring system is electrically connected to a battery, and the battery is used for supplying power to the wireless tire pressure monitoring system,
said method further comprises:
detecting battery level of the battery through the controller; and when the controller determines that the magnetic flux value reaches the predetermined threshold, activating the wireless signal transmitter or raising the transmitting times per minute of the wireless signal transmitter by the controller, and transmitting a signal representing the battery level by the wireless signal transmitter.

8. The method of claim 5, wherein the wireless signal transmitter is a wireless radio frequency signal transmitter.

9. A wireless tire pressure monitoring system provided on a tire or a rim of a vehicle and comprising:
a magnetometer for measuring a magnetic flux value;
a pressure sensor for measuring a pressure value within the tire;
a controller, receiving the magnetic flux value measured by the magnetometer and the pressure value measured by the pressure sensor, and determining whether the magnetic flux value fluctuates; and
a wireless signal transmitter in signal communication with the controller and controlled by the controller,
wherein when the controller determines that the magnetic flux value fluctuates, the controller activates the wireless signal transmitter or raises the transmitting times per minute of the wireless signal transmitter, and the wireless signal transmitter transmits a signal representing the pressure value.

10. The wireless tire pressure monitoring system of claim 9, further comprising:
a temperature sensor for measuring a temperature value within the tire,
wherein the controller receives the temperature value measured by the temperature sensor, and when the controller determines that the magnetic flux value fluctuates, the controller activates the wireless signal transmitter or raises the transmitting times per minute of the wireless signal transmitter, and the wireless signal transmitter transmits a signal representing the temperature value.

11. The wireless tire pressure monitoring system of claim 9, wherein the wireless tire pressure monitoring system is electrically connected to a battery and is supplied power through the battery, the controller can detect battery level of the battery, and wherein when the controller determines that the magnetic flux value fluctuates, the controller activates the wireless signal transmitter or raises the transmitting times per minute of the wireless signal transmitter, and the wireless signal transmitter transmits a signal representing the battery level.

12. The wireless tire pressure monitoring system of claim 9, wherein the wireless signal transmitter is a wireless radio frequency signal transmitter.

13. A wireless tire pressure monitoring system provided on a tire or a rim of a vehicle and comprising:
a magnetometer for measuring a magnetic flux value;
a pressure sensor for measuring a pressure value within the tire;
a controller receiving the magnetic flux value measured by the magnetometer and the pressure value measured by the pressure sensor, and determining whether the magnetic flux value reaches a predetermined threshold; and
a wireless signal transmitter in signal communication with the controller and controlled by the controller,
wherein when the controller determines that the magnetic flux value reaches the predetermined threshold, the controller activates the wireless signal transmitter or raises the transmitting times per minute of the wireless signal transmitter, and the wireless signal transmitter transmits a signal representing the pressure value.

14. The wireless tire pressure monitoring system of claim 13, further comprising:
a temperature sensor for measuring a temperature value within the tire,
wherein the controller receives the temperature value measured by the temperature sensor, and when the controller determines that the magnetic flux value reaches the predetermined threshold, the controller activates the wireless signal transmitter or raises the transmitting times per minute of the wireless signal transmitter, and the wireless signal transmitter transmits a signal representing the temperature value.

15. The wireless tire pressure monitoring system of claim 13, wherein the wireless tire pressure monitoring system is electrically connected to a battery and is supplied power through the battery, the controller can detect battery level of the battery, and wherein when the controller determines that the magnetic flux value reaches the predetermined threshold, the controller activates the wireless signal transmitter or raises the transmitting times per minute of the wireless signal transmitter, and the wireless signal transmitter transmits a signal representing the battery level.

16. The wireless tire pressure monitoring system of claim 13, wherein the wireless signal transmitter is a wireless radio frequency signal transmitter.
